(19) United States
(12) Patent Application Publication
(10) Pub. No.: US 2009/0262403 A1
(43) Pub. Date: Oct. 22, 2009

(54) IMAGE SCANNING APPARATUS

(75) Inventor: Akira Shimatani, Osaka (JP)

Correspondence Address: GLOBAL IP COUNSELORS, LLP, 1233 20TH STREET, NW, SUITE 700, WASHINGTON, DC, 20036-2680, US

(73) Assignee: KYOCERA MITA CORPORATION, Osaka (JP)

(21) Appl. No.: 12/416,741

(22) Filed: Apr. 1, 2009

(30) Foreign Application Priority Data
Apr. 22, 2008 (JP) 2008-111454

(51) Int. Cl. H04N 1/04

(52) U.S. Cl. 358/494

(57) ABSTRACT

An object of the present invention is to produce an image scanning apparatus for preventing occurrence of a black line in the scanning of a sheet of document. A light source 23 is moved between positions A and B when a sheet of a document is scanned while being transported. Accordingly, a scanning position is moved in a sub-scanning direction. Thus, movement of the scanning position makes it possible to prevent or to inhibit the occurrence of a black line on the scanned image.

### CROSS-REFERENCE TO RELATED APPLICATIONS

This application claims priority under 35 U.S.C. § 119 to Japanese Patent Application No. 2008-111454 filed on Apr. 22, 2008. The entire disclosure of Japanese Patent Application No. 2008-111454 is hereby incorporated herein by reference.

### BACKGROUND OF THE INVENTION

1. Field of the Invention

The present invention relates to an image scanning apparatus being configured to obtain image data from an image on a sheet of document.

2. Background Art

An image scanning apparatus with an automatic document feeding mechanism has conventionally had a drawback in that a scanned image often includes a black line. The black line normally arises from an extraneous substance (e.g., dirt or dust) attached on a contact glass. A variety of inventions have been proposed in response to the problem.

For example, Japan Patent Application Publication No. JP-A-2001-272829 discloses an image scanning apparatus. According to the apparatus, a contact glass is configured to be moved while a document is being fed. However, the contact glass is exposed outside the image scanning apparatus. Therefore, a user is capable of touching it, and its movement may cause a safety hazard.

In view of the above, it will be apparent to those skilled in the art from this disclosure that there exists a need for an improved image scanning apparatus. This invention addresses this need in the art as well as other needs, which will become apparent to those skilled in the art from this disclosure.

### SUMMARY OF THE INVENTION

Accordingly, aspects of the present invention have been created to solve the above-mentioned problem occurring in the conventional practice, and to produce an image scanning apparatus for preventing occurrence of a black line in a scanned image without presenting any safety problems to a user.

An aspect of the present invention relates to an image scanning apparatus. The image scanning apparatus includes a scanning section, a scanning position movement section, a document transportation section, and a scanning position control section. The scanning section is configured to obtain image data from a sheet of a document being set in a scanning position per main-scanning line. The scanning position movement section is configured to move the scanning section in a sub-scanning direction perpendicular to the main scanning line. The document transportation section is configured to move consecutively plural sheets of a document or documents one by one in the sub-scanning direction. The scanning position control section is configured to cause the scanning position movement section to move the scanning section in the sub-scanning direction when the image data are obtained from the sheet of document while the sheet of document is being transported.

### BRIEF DESCRIPTION OF THE DRAWINGS

Referring now to the attached drawings which form a part of this original disclosure:

FIG. 1 is a front cross-sectional view illustrating main elements of an image scanning apparatus in accordance with a first preferred embodiment of the present application;

FIG. 2 is a view of a block diagram illustrating main elements of the image scanning apparatus;

FIG. 3A is a view of a diagram illustrating an example of movement of scanning positions on the image scanning apparatus; and

FIG. 3B is a view of a diagram illustrating another example of movement of scanning positions.

### DETAILED DESCRIPTION OF THE EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

### (1) Configuration of Image Scanning Apparatus 1

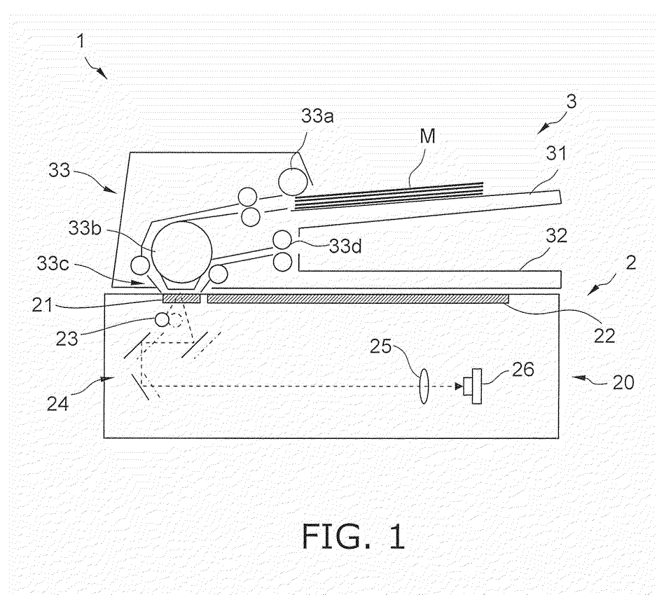

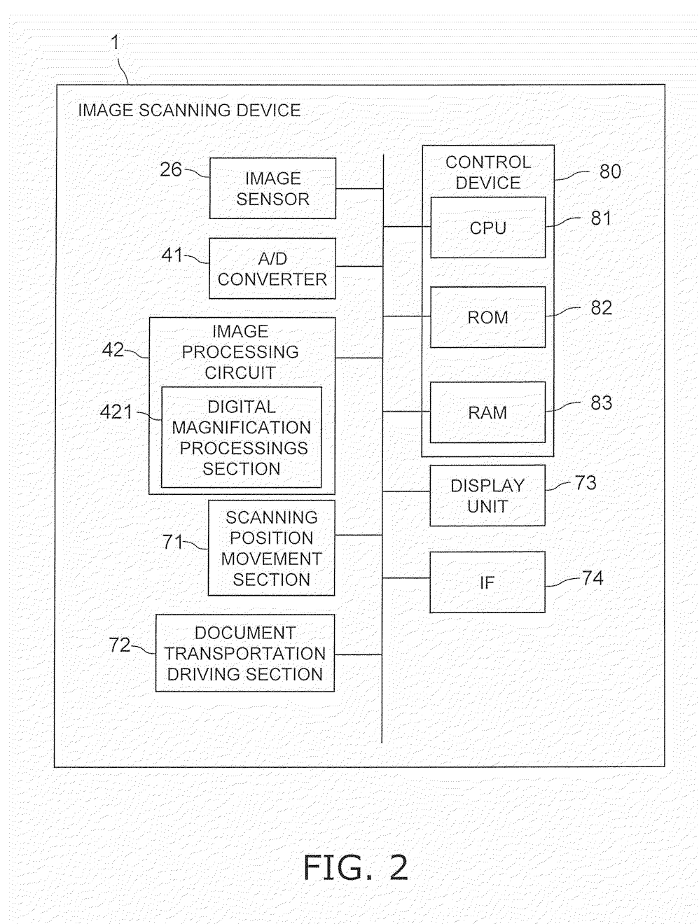

With reference to FIGS. 1 and 2, a configuration of an image scanning apparatus 1 will be hereinafter explained as an embodiment of the present invention. FIG. 1 is a front cross-sectional view illustrating main elements of the image scanning apparatus 1. FIG. 2 is a view of a block diagram illustrating main elements of the image scanning apparatus 1.

As illustrated in FIG. 1, the image scanning apparatus 1 includes a main body 2 and a document feeder 3. The main body 2 includes an image scanning section 20, a document feeder (DF) contact glass 21, and a flat head contact glass 22.

The document feeder 3 is attached to the top of the main body 2. The document feeder 3 is configured to be set in opened/closed positions with respect to the main body 2. The document feeder 3 includes a document disposition tray 31, a document discharge tray 32 and a document transportation section 33. The document transportation section 33 includes a pull-in roller 33a, a transportation roller 33b, a transportation guide 33c, a discharge roller 33d and the like. The pull-in roller 33a pulls a sheet of a document M from a bundle of sheets loaded on the document disposition tray 31. The transportation roller 33b transports a sheet of the document M. The transportation guide 33c guides the sheets of the document M to the DF contact glass 21 while the sheets of the document M are being transported. The discharge roller 33d discharges the scanned sheets of the document M to the discharge tray 32. The sheets of the document M are transported to the upper side of the DF contact glass 21 in a direction perpendicular to an after-mentioned main-scanning direction. Note the direction perpendicular to the main-scanning direction is hereinafter referred to as “a sub-scanning direction.”

The DF contact glass 21 and the flat head contact glass 22 of the main body 2 are preferably transparent glass plates. The contact glasses 21 and 22 are opposed to the document feeder 3.

The image scanning section 20 preferably includes a light source unit 23, a group of mirrors 24, a lens 25, and an image sensor 26.

The light source unit 23 preferably includes a light source and a variety of optical members. For example, the optical members include a mirror arranged to guide the light irradiated from the light source to the contact glasses 21 and 22. The light source unit 23 is configured to irradiate the sheets of the document M with the light from the light source while the sheets of the document M pass through the upper side of the DF contact glass 21 and while the sheets of the document M are placed on the flat head contact glass 22.

The group of mirrors 24 is arranged to guide the light reflected by the sheets of the document M to the lens 25. The lens 25 is arranged to guide the light from the group of mirrors 24 to the image sensor 26. FIG. 1 illustrates an optical pass from the light source unit 23 to the image sensor 26 with a dotted line. The optical members (e.g., the group of mirrors 24) are configured to scan the sheets of the document M with the light from the light source unit 23 per scanning line in the main-scanning direction, i.e., a direction perpendicular to the surface of FIG. 1.

The image sensor 26 is configured to convert the light reflected by the document M into an analog electric signal. The image sensor 26 is thereby configured to obtain image data from the sheets of the document M. Any suitable conventionally-known image sensors may be used as the image sensor 26. Examples of the image sensor 26 are a charge-coupled device (CCD) sensor and a complementary metal-oxide semiconductor (CMOS) sensor.

A position at which the image sensor 26 scans the sheets of the document M, in other words, a position at which the light source unit 23 irradiates the document M, is hereinafter referred to as “a scanning position.”

An after-mentioned scanning position movement section 71 is configured to move the light source unit 23 and the group of mirrors 24 in parallel to a feeding direction of the document M, i.e., sub-scanning direction.

As illustrated in FIG. 2, the image scanning apparatus 1 further includes a variety of elements such as an A/D converter 41, an image processing circuit 42, the scanning position movement section 71, a document transportation driving section 72, a display unit 73, an interface (IF) 74, and a control device 80 (scanning position control section).

As described above, the image sensor 26 is configured to convert the light reflected by the sheets of the document M into the analog electric signal and to obtain the image data from the sheets of the document M per scanning line. The A/D converter 41 is configured to convert the image data per scanning line into multi-valued digital data and to output the multi-valued digital data to the image processing circuit 42.

The image processing circuit 42 is configured to execute a variety of image processing with respect to the image data converted into the multi-valued digital data. The image processing circuit 42 includes a digital magnification processing section 421. The digital magnification processing section 421 is an example of a reduction section and an enlargement section. The digital magnification processing section 421 is configured to enlarge/reduce an image scanned from the sheets of the document M with predetermined digital processing.

Referring to FIGS. 1 and 2, the scanning position movement section 71 includes a rail and a variety of members (e.g., motor and gear). The rail extends in the sub-scanning direction. The motor and the gear are configured to move the light source unit 23 and the group of mirrors 24 on the rail. With this configuration, the scanning position movement section 71 is configured to scan a sheet of the document M placed on the flat head contact glass 22 in the sub-scanning direction. The scanning position movement section 71 is also configured to adjust the scanning position while the sheet of the document M is being transported.

The document transportation driving section 72 is configured to drive a variety of rollers of the document transportation section 33 being arranged to transport the sheets of the document M.

The display unit 73 includes a liquid-crystal display (LCD) panel and the like. The display unit 73 is configured to display a variety of images for a user.

The IF 74 is configured to transmit image data to a printing apparatus (not illustrating in the figure) or other external apparatuses.

The control device 80 is a microcomputer, and includes a central processing unit (CPU) 81, a read-only memory (ROM) 82, a random-access memory (RAM) 83, and the like. The CPU 81 is configured to read out and to run a program stored in the ROM 82. Thus, the CPU 81 realizes a variety of controls. The RAM 83 is configured to function as a working area of the CPU 81. Especially, as a control function, the control device 80 is configured to cause the scanning position movement section 71 to change a scanning position of the sheets of the document M while the sheets of the document M are being transported. Details of the control function will be hereinafter explained.

The image scanning apparatus of the present embodiment may be installed in a copier or a multifunctional peripheral (MFP).

### (2) Control of Scanning Position

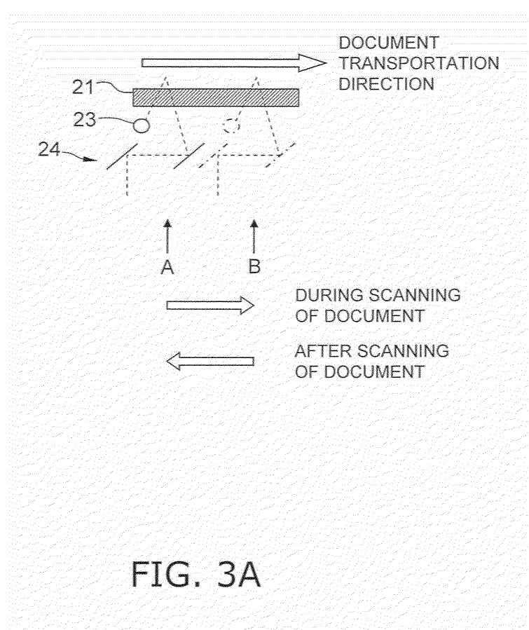

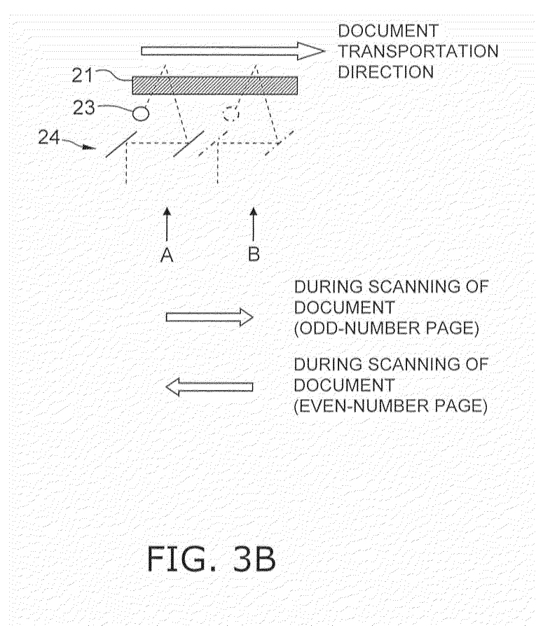

Scanning position control during scanning of a sheet of the document M will be hereinafter explained with reference to FIG. 3.

As illustrated in FIG. 3, when a sheet of the document M is scanned through the DF contact glass 21 while the document feeder 3 feeds the document M, the control device 80 is configured to cause the scanning position movement section 71 to move the light source unit 23 in the sub-scanning direction during scanning of the document M, i.e., while the document M passes through the upper side of the DF contact glass 21. This means that the scanning position is moved in conjunction with the movement of the light source unit 23. The group of mirrors 24 is also moved in conjunction with the movement of the light source unit 23 to guide the reflected light into the image sensor 26.

Thus, it is possible to prevent occurrence of a black line arising from an extraneous substance attached on the contact glass 21 or reduce length of a black line if any by moving the scanning position in the sub-scanning direction during scanning of the document M.

Furthermore, the scanning position is moved in accordance with movement of the scanning section without moving a member easily touched by a user (e.g., contact glass). Accordingly, this does not cause any safety hazard.

Furthermore, the scanning position movement section 71 is used for both control of the scanning position and scanning of the sheets of the document M through the flat head contact glass 22. Accordingly, the image scanning apparatus 1 of the present embodiment has an advantage in that it does not need another complex element.

Also, the speed for moving the scanning position is not particularly set in the embodiment. However, when the speed is set to be constant, magnification of the image data obtained from the document M in the sub-scanning direction will be accordingly constant. The following are examples of control of the scanning position.

### (2-1) Example 1

As illustrated in FIGS. 3A and 3B, a range between positions A and B is defined as a moving range of the scanning position in the sub-scanning direction. In the present example, as illustrated in FIG. 3A, the control device 80 is configured to move the scanning position to the position B from the position A along the document transportation direction during scanning of a sheet of the document M. On the other hand, the control device 80 is configured to move the scanning position to the position A from the position B while the document is not being scanned.

When plural sheets of documents are consecutively scanned one by one, the control device 80 may be configured to move the scanning position in one direction from the position A to the position B during scanning of the plural sheets of documents. In this case, the control device 80 may also be configured to move the scanning position to the position A from the position B after scanning of the plural sheets of documents. In other words, the scanning position is not returned to the position A from the position B while the sheets of documents are passing from the position A to the position B, and is returned to the position A from the position B after the last one of the plural sheets of documents has passed over the position B.

Alternatively, the control device 80 may be configured to move the scanning position from the position A to the position B while a sheet of a document is being scanned, and to move the scanning position subsequently returned to the position A from the position B before the next sheet is scanned. In other words, the scanning position is moved from the position A to the position B during the passing of a sheet of document from the position A to the position B, and is returned to the position A from the position B between the time after passing the sheet through the position B and before entering the next sheet to position A.

According to the former case, i.e., when the scanning position is moved from the position A to the position B without being returned to the position A while the plural sheets of documents are all scanned, it is not necessary to set a period of time for returning the scanning position to the position A from the position B before the next scanning processing is started. Therefore, it takes a relatively short time to scan all the documents.

On the other hand, according to the latter case, i.e., when the scanning position is returned to the position A from the position B every time a sheet of document is scanned, the control device 80 may be configured to move the scanning position relatively faster than in the former case. Consequently, it is possible to reduce the length of a black line in the image data.

The scanning position is thus moved in both of the above-mentioned cases. Therefore, relative moving speed of a sheet of a document with respect to the scanning position in the case of the dynamic scanning position is different from that in the case of the static scanning position.

When the document transportation speed and the main-scanning directional scanning speed in the case of the dynamic scanning position are set to be the same as those in the case of the static scanning position, the sub-scanning directional size of the scanned image in the case of the dynamic scanning position will be larger than that in the case of the static scanning position even if the identical document is scanned in both cases.

In this case, it is possible to obtain a scanned image of the same magnification as an image on the document (hereinafter referred to as “original image”) by suitably regulating scanning timing in the main and sub-scanning directions, i.e., main-scanning directional scanning speed and the document transportation speed. For example, when the main-scanning directional scanning speed in the case of the dynamic scanning position is set to be the same as that in the case of the static scanning position, the document transportation speed in the case of the dynamic scanning position may be speeded up to set a difference between the document transportation speed and the moving speed of the scanning position in the case of the dynamic scanning position to be identical to that in the case of the static scanning position. On the other hand, when the document transportation speed in the case of the dynamic scanning position is set to be the same as that in the case of the static scanning position, the main-scanning directional scanning speed in the case of the dynamic scanning position may be slowed down. Alternatively, both the document transportation speed and the main-scanning directional scanning speed may be regulated. Both of the document transportation speed and the main-scanning directional scanning speed may be regulated by the control device 80.

### (2-2) Example 2

As illustrated in FIG. 3B, moving direction of the scanning position may be changed depending on the pages of the documents. In the present example, the control device 80 is configured to move the scanning position in the same direction as the document transportation direction, i.e., from the position A to the position B, with respect to the odd-number pages of the documents. On the other hand, the control device 80 is configured to move the scanning position in the direction opposite to the document transportation direction, i.e., from the position B to the position A, with respect to documents of the even-number pages of the documents.

The absolute value of the moving speed of the scanning position with respect to the documents of the odd-number pages and that with respect to the documents of the even-number pages may be identical to or different from each other.

In this case, relative moving speed of the documents of the odd-number pages with respect to the scanning position is different from that of the documents of the even-number pages with respect to the scanning position. Accordingly, sub-scanning directional magnification of an image obtained from a sheet of document of the odd-number page is different from that obtained from a sheet of document of the even-number page.

Accordingly, the digital magnification processing section 421 is configured to execute digital magnification processing to obtain a scanned image of the same magnification as the original image regardless of pages of documents.

For example, the document transportation speed is defined as “v” in the case of the static scanning position. In this case, the size of a scanned image is assumed to be the same as that of the original image. On the other hand, in the case of the dynamic scanning position, the moving speed of the scanning position is defined as “k×v” with respect to documents of the odd-number pages. “k” is a constant number. The range of “k” is greater than 0 and less than 1. Additionally, the relative moving speed of the documents of the odd-number pages with respect to the scanning position is defined as “(1−k)×v.” In this case, the digital magnification processing section 421 is configured to execute digital reduction processing. Specifically, the image scanned from a sheet of document of the odd-number page is magnified at magnification of “1−k” in the sub-scanning direction by the digital magnification processing section 421. Accordingly, the size of the scanned image will be the same as that of the original image of the sheet of document of the odd-number pages.

However, when the moving speed of the scanning position with respect to the documents of the even-number pages is set to be the same as that with respect to the documents of the odd-number pages, the relative moving speed of the documents of the even-number pages with respect to the scanning position is defined as “(1+k)×v”. This is because the moving direction of the scanning position with respect to the documents of the even-number pages is opposite to that with respect to the documents of the odd-number pages. Therefore, the digital magnification processing section 421 is configured to execute digital magnification processing. Specifically, the image scanned from a sheet of document of the even-number page is magnified at magnification of “1+k” in the sub-scanning direction. Accordingly, size of the magnified image is the same as that of the original image of the sheet of document of the even-number page.

By the way, some apparatuses show lower image quality when executing the digital magnification processing. In this case, the control device 80 is configured to regulate the document transportation speed and the main-scanning directional scanning speed to obtain a scanned image of the same magnification as the original image of the even-number page, without the digital magnification processing, when the relative moving speed is “(1+k)×v”. On the other hand, the digital magnification processing section 421 is configured to execute digital reduction processing to obtain a scanned image of the same magnification as the original image from a sheet of document of the odd-number page. Specifically, the image scanned from a sheet of document of the odd-number page is reduced at magnification of “(1−k)/(1+k)” in the sub-scanning direction.

Also, the control device 80 is configured to set moving speed of the scanning position by setting moving distance of the scanning position to be equal to or less than distance from the position A to the position B in a period of time elapsed since the travel-directional front end of a sheet of document enters the scanning position until the travel-directional rear end of the sheet of document passes through the scanning position. Therefore, the image scanning apparatus 1 scans all over a sheet of document. For example, the moving speed of the scanning position may be set depending on the maximum size of a sheet of a document allowed to be fed by the document feeder 3. Additionally, any suitable sensors may be provided to detect the size of a sheet of a document. In this case, the sensor may be configured to detect the size of a sheet of a document in the sub-scanning direction before the sheet of the document reaches the scanning position. The moving speed of the scanning position may be subsequently set based on the detected size of a sheet of the document in the sub-scanning direction.

### GENERAL INTERPRETATION

A used herein, the following directional terms “forward, rearward, above, downward, vertical, horizontal, below, and transverse” as well as any other similar directional terms refer to those directions of a device equipped with the present invention. Accordingly, these terms, as utilized to describe aspects of the present invention, should be interpreted relative to a device equipped with the present invention.

The term “configured” as used herein to describe a component, section or part of a device includes hardware, and/or software that is constructed and/or programmed to carry out the desired function.

Terms that are expressed as “means-plus function” in the claims should include any structure that can be utilized to carry out the function of that part of the present invention.

The term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applied to words having similar meanings such as the terms, “including,” “having,” and their derivatives. Also, the term “part,” “section,” “portion,” “member,” or “element” when used in the singular can have the dual meaning of a single part or a plurality of parts.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. An image scanning apparatus, comprising:
a scanning section being configured to obtain image data from a sheet of a document in a scanning position per main-scanning line;
a scanning position movement section being configured to move the scanning section in a sub-scanning direction perpendicular to the main-scanning line;
a document transportation section being configured to transport consecutively plural sheets of the document one by one in the sub-scanning direction; and
a scanning position control section being configured to cause the scanning position movement section to move the scanning section in the sub-scanning direction when the image data are obtained from the sheet of document while the sheet of document is being transported.

2. The image scanning apparatus according to claim 1, wherein
the scanning position control section is configured to move the scanning position at constant speed while the image data are obtained from the sheet of document.

3. The image scanning apparatus according to claim 1, wherein
the scanning position control section is configured to move the scanning position in the same direction with respect to a document transportation direction of the plural sheets of the document.

4. The image scanning apparatus according to claim 1, wherein
the scanning position control section is configured to move the scanning position in a document transportation direction with respect to a first of any two consecutive sheets of the plural sheets of the document, and the scanning position control section is configured to move the scanning position in a direction opposite to the document transportation direction with respect to a second of the any two consecutive sheets of the plural sheets of the document.

5. The image scanning apparatus according to claim 4, further comprising
a reduction section configured to reduce a size of an image obtained from the first of the any two consecutive sheets of the plural sheets of the document in the sub-scanning direction.

6. The image scanning apparatus according to claim 4, further comprising
an enlargement section configured to enlarge size of the image data obtained from the second of the any two consecutive sheets of the plural sheets of the document in the sub-scanning direction.
